(19) United States
(12) Patent Application Publication
(10) Pub. No.: US 2004/0058112 A1
(43) Pub. Date: Mar. 25, 2004

(54) Method for making tubular articles

(75) Inventors: Doug Williams, San Rafael, CA (US); Jeff Shea, Richmond, CA (US); Michael Cork, Richardson, TX (US); Ray Wellman, Vallejo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ATS Products, Inc., Richmond, CA

(21) Appl. No.: 10/255,125

(22) Filed: Sep. 25, 2002

(51) Int. Cl. B32B 1/08

(52) U.S. Cl. 428/36.91

(57) ABSTRACT

Tubular structures and methods for making tubular structures are disclosed. In one embodiment, the method for making a tubular structure includes modifying a surface of a structure. After modifying the surface, the structure is bonded to a metal layer, thereby forming a composite sheet. Then, the composite sheet is shaped into a tubular structure.

### BACKGROUND OF THE INVENTION

Tubular structures are used in many diverse industries to carry fluids such as gases and liquids. Sometimes, these fluids contain caustic or corrosive materials. For example, industries such as the semiconductor industry, the plating industry, and the pharmaceutical industry use air ducts to transport corrosive or caustic gases from a processing center away from workers. Wastewater treatment plants also use pipes to transport corrosive chemicals such as chlorine, and caustics such as sodium hydroxide or sodium hypochlorite to a processing center to process sewage.

While existing tubular structures are adequate for transporting caustic or corrosive fluids, they could be improved. For example, fiber-reinforced plastic (FRP) ducts have been used to transport corrosive gases. However, many fiber-reinforced plastic ducts have poor flame and smoke properties. Pure metal ducts have also been used to transport gases. Pure metal ducts have good flame and smoke properties as metal does not burn like plastic. However, many pure metal ducts do not form good barriers to corrosive gases.

Embodiments of the invention address these and other problems, individually and collectively.

### SUMMARY OF THE INVENTION

Embodiments of the invention are directed to tubular structures such as air ducts and methods for making the same. The tubular structures are desirably fire-resistant, and are also chemically resistant. Although the air ducts and their manufacture are described in detail herein as preferred embodiments, embodiments of the invention are not limited to air ducts.

One embodiment of the invention is directed to a method for making a tubular structure, the method comprising: (a) modifying a surface of a fluoropolymer film; (b) after (a), bonding the fluoropolymer film to a metal layer, thereby forming a composite sheet; and (c) shaping the composite sheet into a tubular structure.

Another embodiment of the invention is directed to a tubular structure comprising: (a) a metal layer; (b) a fluoropolymer film; (c) an adhesive layer between the metal layer and the fluoropolymer film; and (d) a helical seam formed in the tubular structure.

Another embodiment of the invention is directed to a method for forming a tubular structure, the method comprising: (a) wrapping a surface modified fluoropolymer film around a mandrel; (b) wrapping a layer of fabric material on the fluoropolymer film and saturating the layer of fabric material with a resin material; (c) curing the resin material to form a tubular structure; and (d) removing the tubular structure from the mandrel.

These and other embodiments of the invention are described in further detail below.

### BRIEF DESCRIPTION OF THE DRAWINGS

FIG. 1 shows an axial cross-section of a three-layered tubular structure according to an embodiment of the invention.

FIG. 2 shows a schematic side view of a process of laminating a metal layer to a fluoropolymer film.

FIG. 3 shows a top view of an exemplary apparatus that can be used to spirally wind a composite sheet into a tubular structure with a helical seam.

FIG. 4 shows a cross-sectional view of a roller as it forms seam elements in a composite sheet.

FIG. 5 shows a composite sheet with seam elements.

FIG. 6 shows how a composite sheet can be spirally wound to form a tubular structure.

FIGS. 7(a)-7(d) show schematic illustrations of how a tubular structure can be formed using a mandrel.

### DETAILED DESCRIPTION

In embodiments of the invention, the tubular structures may be pipes (e.g., fluid pipes or pressure pipes), conduits, or air ducts. Preferably, the tubular structures are air ducts that are capable of carrying caustic and/or corrosive gases, as well as oxidizing agents such as HF and ozone. The air ducts according to embodiments of the invention may also be fire-resistant. Advantageously, the air ducts according to embodiments of the invention can pass FM Duct Test Standard #4922, and can also transport caustic and/or corrosive gases. FM Duct Test Standard #4922 is described in further detail below. Embodiments of the invention could also satisfy other standards.

The tubular structures according to embodiments of the invention may have any suitable cross-sectional shape. For example, the cross-sections of the tubular structures may be circular, oval, rectangular, square, etc.

I. Tubular Structures Containing a Metal Layer and a Fluoropolymer Film

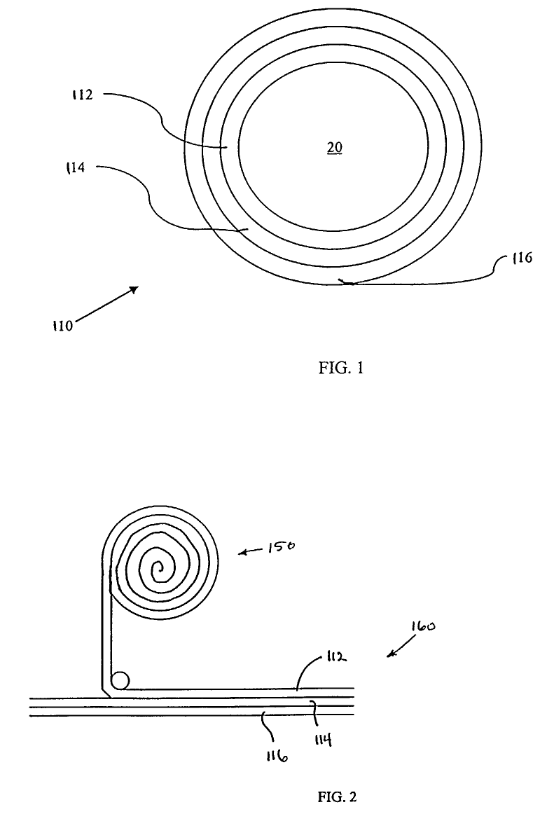

FIG. 1 shows an axial cross-section of a tubular structure 110 according to an embodiment of the invention. The tubular structure 110 includes an inner layer comprising a fluoropolymer film 112, an intermediate adhesive layer 114, and an outer metal layer 116. The inner fluoropolymer film 112 can form a barrier for, for example, a corrosive, caustic, or oxidizing fluid passing through the tubular structure 110.

Although the tubular structure 110 shown in FIG. 1 has three distinct layers, it is understood that the tubular structures according to embodiments of the invention may have any suitable number of layers. For instance, any suitable number of layers may be between the fluoropolymer film 112, and the intermediate adhesive layer 114. Also, although metal layer 116 is referred to as an “outer metal layer” in this example, there may be other layers on top of the metal layer 116 in some embodiments of the invention. The words “inner” and “outer” to describe the fluoropolymer film 112 and the metal layer 116 are intended to refer to the relative positions of these layers, and not necessarily their absolute positions within a tubular structure.

Although the fluoropolymer film 112 is shown as being the innermost layer in the tubular structure 110 in FIG. 1, it could be embedded within inner and outer layers in a tubular structure. For example, it is possible to sandwich a fluoropolymer film (e.g., a 3 mil layer of ECTFE) between an inner vinyl ester layer (e.g., 25 mils thick), and an outer phenolic resin layer in a duct according to an embodiment of the invention.

In some embodiments, a fluoropolymer layer (not shown) could be formed on the outer metal layer 116. For example, the additional fluoropolymer layer could be the outermost layer of the tubular structure. This can be desirable if the outer surface of the tubular structure 110 is intended to be resistant to corrosive, caustic, or oxidizing fluids. The outer fluoropolymer layer may comprise the same or different material than the fluoropolymer film 112.

The metal layer 116 may comprise any suitable metal. For example, in some embodiments, the metal layer 116 may comprise a malleable metal such as aluminum or alloys thereof, galvanized steel, stainless steel, or mild steel.

The fluoropolymer film 112 may be in any suitable form. Preferably, the fluoropolymer film 112 is in the form of an impervious sheet of fluorpolymeric material. The fluoropolymer film 112 may have any suitable thickness including a thickness that is less than about 100 mils.

The fluoropolymer film 112 can be filled or unfilled. For instance, the fluoropolymer film 112 may incorporate particles or fibers. In some embodiments, the particles may be conductive particles that can render the fluoropolymer film 112 conductive. In some instances, it may be desirable to make the tubular structure 110 conductive. A conductive cleanroom duct, for example, can desirably dissipate electrical charges (e.g., static electricity). Such electrical charges could trigger a fire or an explosion if explosive gases are present.

As used herein, a “fluoropolymer film” may contain any suitable fluoropolymer. It may include, for example, a homopolymer or copolymer formed from monomer units containing fluorine. Examples include ethylene-tetrafluoroethylene (ETFE), ethylene-chlorotrifluoroethylene (ECTFE), fluorinated ethylenepropylene (FEP), perfluoroalkoxy (PFA), polyvinylfluoride (PVF), polyvinylidene fluoride (PVDF), polychlorotrifluoroethylene (PCTFE), polytetrafluoroethylene (PTFE), and blends thereof. Such fluoropolymer films are commercially available. Another suitable fluoropolymer material is polytetrafluoroethylene-perfluoromethylvinylether co-polymer (or MFA resin) commercially available from Zeus Products of Orangeburg, S.C.

Fluoropolymer films are easier to process than, for example, fluoropolymer powders that might be baked onto an inner surface of a metallic tube. A fluoropolymer layer formed using this latter process needs to be relatively thick to reduce the likelihood of forming pinholes in the formed liner. On the other hand, fluoropolymer films are pre-formed and can be made thin and impermeable. It is also difficult to form a smooth and even inner liner with a powder coating process. On the other hand, fluoropolymer films are pre-formed and can have a uniform thickness. In addition, fluoropolymers generally have high melting temperatures so that high heat is needed to bond fluoropolymer powders to a metallic substrate. In embodiments of the invention, because the fluoropolymer films are surface modified, relatively low heating (or even ambient) temperatures can be used to bond them to other materials such as adhesives. Accordingly, the use of a fluoropolymer film to form a tubular structure has advantages over powder coating processes.

A preferred fluoropolymer is ECTFE. ECTFE is a melt-processable fluoropolymer with a 1:1 alternating copolymer structure of ethylene and chlorotrifluoroethylene. ECTFE is manufactured as HALAR™ pellets by the Ausimont USA plant in Orange, Tex. ECTFE provides excellent chemical and abrasion resistance, extremely low permeability to liquids, gases and vapors, a low dielectric constant, stability at a broad range of temperatures (e.g., between cryogenic temperatures and 300° F. (149° C.)), and low smoke generation. ECTFE also has excellent chemical resistance to a wide variety of corrosive chemicals and organic solvents, as well as to strong acids, chlorine, and aqueous caustics. No known solvent dissolves or stress cracks ECTFE at temperatures below 250° F. (120° C.). The pellet form of ECTFE can then be converted into a powder, or a layer.

The final dimensions and geometry of the tubular structure 110 can vary. In exemplary embodiments, the entire thickness of the tubular structure 110 could be less than about 5 millimeters. The inner and outer diameters of the formed tubular structure 110 may also vary in embodiments of the invention. An air duct, for example, may have an inner diameter and outer diameter that is greater than about 1 inch in some embodiments. The tubular structure 110 may also be of any suitable length. Also, although the tubular structures are often described as being cylindrically-shaped, they could also be in the form of curved structures such as elbows.

The surface of the fluoropolymer film 116 can be modified so that it can be bonded to the metal layer 116. Fluoropolymeric materials that are not surface-modified are difficult to adhere to other materials, because of the inert nature of fluoropolymers. After modifying a surface of the fluoropolymer film 112, it is bonded to a metal layer to form a composite sheet. Then, the composite sheet is shaped into a tubular structure. Preferably, the composite sheet is spirally wound upon itself so that a tubular structure is formed. The resulting composite may have a helical seam.

Any suitable process may be used to modify the surface of the fluoropolymer film 112. Suitable processes include etching, corona discharge, and exposing the fluoropolymer film 112 to reactive gases. In embodiments of the invention, one or both sides of the fluoropolymer film 112 may be modified using such processes to improve the bondability fluoropolymer film 112 to other materials.

In some embodiments, after the surface of the fluoropolymer film 112 is modified, the “contact angle” of the surface decreases. When a droplet of liquid is placed on a solid surface and the surface tension of the liquid is larger than the surface tension of the solid, the droplet makes a definite angle of contact, that is, the surface contact angle, between the liquid and solid. When the same liquid is placed on surfaces of increasing surface tension (i.e., of increasing surface energy), the surface contact angle decreases as the surface tension of the solid increases. On a high surface energy material, an adhesive can flow (or “wet-out”) to ensure that a relatively strong bond is present between the fluoropolymer film and the adhesive in contact with it. Thus, the surface contact angle is a measure of the hydrophilicity of a surface. As defined herein, the surface contact angle is the angle formed by a plane normal to a generally planar surface and a tangent line at a peripheral point of contact of a droplet of pure, deionized water placed on the surface. In some embodiments, the modified surface of the fluoropolymer film 112 can have a contact angle of less than about 50 degrees.

The contact angle of the fluoropolymer film 112 can be modified in any suitable manner. In some embodiments, the contact angle can be modified by exposing the fluoropolymer film to a reactive gas. For example, each surface of a fluoropolymer film is exposed to a reactive gas composition including effective concentrations of molecular fluorine and molecular oxygen for a period of time sufficient to increase the surface energy of the surface. This also decreases the surface contact angle to allow bonding between the surface and an adhesive that is on the surface.

In some embodiments, a reactive gas process can be used to modify a surface of a fluoropolymer film. Illustratively, the reactive gas can contain molecular fluorine (F₂) and molecular oxygen (O₂) together with an inert carrier such as molecular nitrogen (N₂). The absolute concentrations of fluorine and oxygen can vary in the reactive gas composition. The absolute concentrations depend both on the respective volume percent concentrations and the gas pressure. For example, the reactivity of a gaseous composition with 12 percent by volume F₂ at 1.0 atmosphere pressure approximately equals the reactivity of a gaseous composition with 24 percent by volume F₂ at 0.5 atmosphere or 4 percent by volume F₂ at 3.0 atmospheres. Shorter exposure times can be used if the volume percent concentrations and/or partial pressures of the gases are increased. Processing conditions such as temperature, pressure, concentrations of the fluorine and oxygen, and exposure time can be selected by those of ordinary skill in the art so that the temperature rise of a surface modified fluoropolymer film does not exceed the melt temperature of the product.

In some embodiments, F₂ is generally present in the composition in an amount from about 7 to about 25 percent by volume and, preferably, in an amount from about 10 to about 15 percent by volume. O₂ is generally present in the composition in an amount from about 7 to about 25 percent by volume and, preferably, in an amount from about 10 to about 15 percent by volume. The balance of the composition to 100% by volume can comprise an inert carrier gas. Fluoro-oxidation of an ECTFE layer, for example, can be carried out over a temperature range of about 45° F. to about 250° F., and a pressure range of about 0.1 atmosphere to about 3.0 atmospheres. Further details regarding the above-identified process can be found in U.S. patent application No. 09/659,155, which is herein incorporated by reference in its entirety.

In another embodiment, surface of the fluoropolymer film can be modified using a corona discharge process. The contact angle of a surface of a fluoropolymer film can also be decreased using the corona discharge process. Apparatuses suitable for the corona treatment of layers are well known in the art. For example, a corona discharge apparatus is described in U.S. Pat. No. 3,133,193, which is herein incorporated by reference in its entirety. Generally, a suitable corona discharge apparatus includes a grounded metal roller with an insulated cover, and an electrode mounted parallel to the cylinder axis of the roll. The fluoropolymer film passes over the insulated roll, and the corona is developed between the electrode and the fluoropolymer film. The electrode gap, which is the distance between the electrode and the insulated roller cover can be about 30 to about 100 mils in some instances. The corona discharge apparatus may include a means for supplying nitrogen, and a means for maintaining the nitrogen atmosphere, while excluding ambient air.

The amount of energy applied to the fluoropolymer film may vary. The energy applied can be expressed as the power constant, which is traditionally in units of watt-minutes per square foot of layer. The power constant is equal to the corona power, in watts, divided by the product of the layer width and the line speed, in feet per minute.

The corona power required can vary with the size of the apparatus, the rate of treatment of layer, and the particular fluoropolymer film being treated. For example, a small, laboratory scale corona treater may be designed to treat a web of layer 4 inches wide, at a rate of about 7 to 72 feet per minute. Such an apparatus may use a discharge of about 50 to about 150 watts in order to obtain a suitable power constant. Larger commercial corona treaters require correspondingly more power. For example, treating a 6 foot wide layer web at a line speed of 500 or 1000 feet per minute, the required corona power is 9 or 18 kW, respectively, to obtain a power constant of 3 W-min/ft². A laboratory scale treater may have an electrode area of about 0.36 to about 2.25 square inches, so that the electrode energy density is typically in the range of about 44 to about 150 watts/in². A commercial unit would have a correspondingly larger electrode area.

In another embodiment, the surface of the fluoropolymer film may be modified using a wet etching process such as a sodium naphthalate process (sometimes referred to as a sodium etch process). That process involves first solvent cleaning the surface to be modified followed by abrasion. Suitable solvents include acetone and methyl ethyl ketone. Then, a solution is prepared by mixing sodium metal, naphthalene and tetrahydrofuran. This solution is then used to etch the fluoropolymer film. A fluoropolymer film may be dipped, sprayed, or otherwise contacted with the etching solution. Fluoropolymer films that are surface modified using sodium naphthalate processing are commercially available from Acton Technologies, Inc. of Pittston, Pa.

In yet another embodiment, one or both surfaces of a fluoropolymer film can be modified by a plasma etch process. Plasma etch processes are known in the art. A typical plasma reactor system is essentially a containment chamber containing a vacuum chamber and electrodes attached to a power supply for initiating a plasma state of the reactive gas. Two electrodes are in a stainless steel bell jar reactor, one is a lower grounded anode made of stainless steel and another is an upper cathode made of stainless steel, about 5 inches in diameter connected to about a 13.56 MHz external power supply. The inter-electrode gap can be about 1 inch. A fluoropolymer film may be placed in the chamber. The plasma produced in the chamber can be used to modify the surface of the fluoropolymer film.

After the surface of the fluoropolymer film is modified, the surface-modified fluoropolymer film may bonded to a metal layer to form a composite sheet. The composite sheet may have any suitable number of layers. In some embodiments, an adhesive material may be used to bond the metal layer to the fluoropolymer layer. The resulting composite sheet can be sufficiently malleable so that it can be shaped into a tubular structure.

Any suitable adhesive may be used to bond the fluoropolymer film to the metal layer. Suitable adhesives include thermosetting adhesives such as epoxy, acrylate, melamine formaldehyde, phenol formaldehyde, polyester, polyurethane, and resorcinol formaldehyde adhesives.

In some embodiments, the surface modified fluoropolymer film may be laminated to the metal layer. A roll lamination process may be used to laminate the fluoropolymer film to the metal layer. After lamination, if desired, the composite may be compressed and/or heated to facilitate further bonding between the metal layer and the fluoropolymer film. This may be done with or without an adhesive.

The adhesive that is used to bond the fluoropolymer film and the metal layer together may be on the fluoropolymer film and/or the metal layer prior to lamination. The adhesive may be applied to the metal layer and/or the fluoropolymer film in any suitable manner. For example, a roller coating, doctor blade, or curtain coating process can be used to apply an adhesive to the fluoropolymer film and/or the metal layer prior to laminating them together.

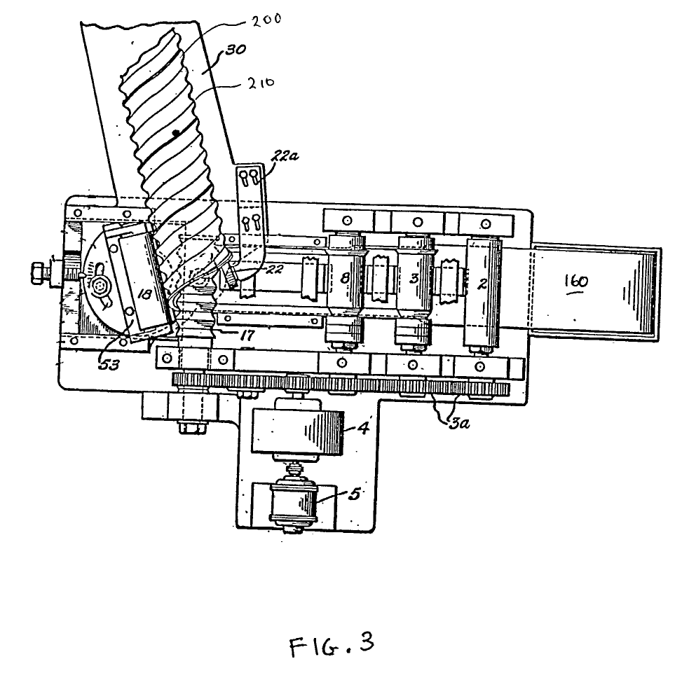

FIG. 2 shows a schematic side view of a surface-modified, fluoropolymer film 112, being roll laminated to a metal layer 116. Referring to FIG. 2, a roll 150 may contain the fluoropolymer film 112 that has been surface modified. The fluoropolymer film 112 may be dispensed from the roll 150 and may be laminated to an adhesive layer 114 that is on top of a metal layer 116. The resulting combination of the fluoropolymer film 112, the adhesive layer 114, and the metal layer 116 can form a composite sheet 160 that can be subsequently shaped.

In some embodiments, the fluoropolymer film 112 may be spaced inwardly from the edges of the metal layer 116. For example, the width of the fluoropolymer film 112 may be narrower than the width of the metal layer 116 by about ½ inch (e.g., about ¼ inch inward from each edge) in some embodiments. This may help to ensure that the fluoropolymer film 112 remains on the inside of the formed tubular structure.

The composite sheet 160 comprising the fluoropolymer film 112, the adhesive layer 114, and the metal layer 116 may be shaped using any suitable process. For example, in some embodiments, two opposite ends of a composite sheet can be joined to form a tubular structure with a longitudinal seam. The resulting tubular structure could have a rectangular, circular, or oval cross-section. However, in other embodiments, the composite sheet 160 is shaped by spirally winding the composite into a tube.

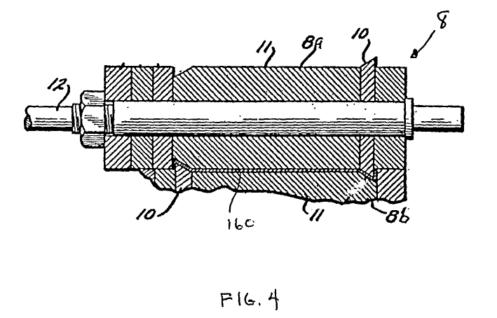

A process for shaping a composite sheet 160 using a spiral winding process can be described with reference to FIGS. 3-6. After forming the metal/fluoropolymer composite sheet 160, it is spirally wound into a tubular structure such as a duct.

FIG. 3 shows a top view of an apparatus that can be used to spirally wind a composite sheet into a tubular structure. Referring to FIG. 3, a composite sheet 160 is fed through a pair of rollers 2. Each roller is journaled at their ends, the rollers being driven by a gear train 3a. A gear reducer 4 is coupled to the gear train 3a and is driven by a motor 5. After the composite sheet 160 leaves the rollers 2, it passes through two other pairs of rollers 3, 8 which are mounted and driven in a manner similar to the pair of rollers 2 (only the top of each roller or each roller pair is shown in FIG. 3). The other parts of the apparatus shown in FIG. 3 are described below.

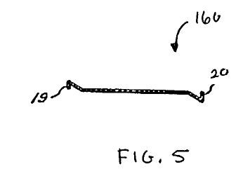

FIG. 4 shows a cross-sectional view of rollers 8a, 8b. Referring to FIG. 4, a shaft 12 which is journaled at its ends carries a hardened beveled disk 10, which is arranged to push one edge of the composite sheet 160 downward into a recess provided on the mating roller 8a of the pair of rollers 8 to form a first seam element in the composite sheet 160. For simplicity of illustration, the individual layers of the composite sheet 160 are not shown in FIGS. 4-6. A spacing unit 11 which is tapered at its end, provides a recess into which an outer edge of the composite sheet 160 is pushed upward by a corresponding disk 10 of the mating roller 8b to form a second seam element.

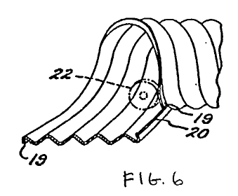

Upon leaving the pair of rollers 8, the composite sheet 160 has a cross-sectional form as in FIG. 5. The composite sheet 160 has first and second seam elements 19, 20 at opposite sides of the composite sheet 160.

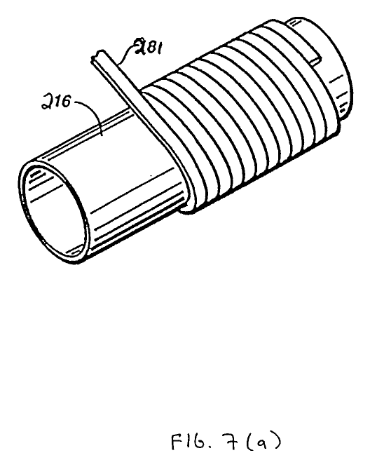

FIG. 6 shows how the first and second seam elements 19, 20 engage each other when the composite sheet 160 is spirally wound upon itself. As shown in FIG. 6, as the composite sheet 160 is spirally wound, the first seam element 19 enters the second seam element 20 and they are engaged. A hold-in roller 22 (shown in phantom lines) helps to form the tubular structure. The engaged first and second seam elements 19, 20 will eventually form a helical seam in the tubular structure.

Referring again to FIG. 3, the hold-in roller 22 is mounted to a bracket 22a, which is attached to a frame forming assembly 30. A pair of rollers 17 downstream of the previously described pairs of rollers 2, 3, 8 can corrugate the composite sheet 160 before it is formed into a tubular structure. Just beyond the rollers 17 is a forming roller 18. The forming roller 18 is mounted on a bracket 53. As the composite sheet 160 emerges from the rollers 17, it impinges upon the angularly disposed forming roller 18. After the composite sheet 160 contacts the forming roller 18, it is helically bent upward so that the composite sheet 160 continues to be helically wound through the cooperation of the roller 22 and the interengaged seam elements. As shown in FIG. 3, the composite sheet 160 is spirally wound, and the interengaged seam elements form a helical seam 210 in the tubular structure 200. If desired, the helical seam 210 can be coated with an appropriate sealant to ensure that the helical seam is fluid impermeable. Suitable seam sealers may include fluoropolymeric materials (e.g., Viton), vinyl-ester materials, or any other suitable sealing materials. Thermosetting resins can be used as seam sealers.

The tubular structure 200 may be a duct that is capable of carrying corrosive and/or caustic gases. After winding the composite sheet 160, the fluoropolymer film eventually resides at an inner surface of the formed tubular structure 200 and the metal layer is outside of the fluoropolymer film.

The metal/fluoropolymer tubular structures described above have a number of advantages. First, they are relatively easy and inexpensive to make. Second, the tubular structures, as a whole, can also have low flame and smoke properties as compared to structurally similar FRP ducts and conventional coated metal ducts. Third, the use of a fluoropolymer inner liner makes the tubular structure particular useful for transporting corrosive and/or caustic fluids. Thus, the tubular structures according to embodiments of the invention can be made quickly and inexpensively, can have low flame and smoke properties, and can be adapted to transport caustic and/or corrosive fluids.

II. Tubular Structures Including Fiber-reinforced Plastics and Fluoropolymer Films

Other embodiments of the invention are directed to forming tubular structures with a fluoropolymer layer and at least one fiber-reinforced plastic (FRP) layer. In one embodiment, a method includes wrapping a surface modified fluoropolymer film around a mandrel. Then, a layer of fabric material is wrapped on the fluoropolymer film and the mandrel. Before, after, or during the wrapping of the fabric material around the mandrel, the layer of fabric material is saturated with a resin material. Then, the resin material is cured. Additional steps may be performed, and a tubular structure is eventually formed. After the tubular structure is formed, it is removed from the mandrel. In these embodiments, a metal layer need not be present.

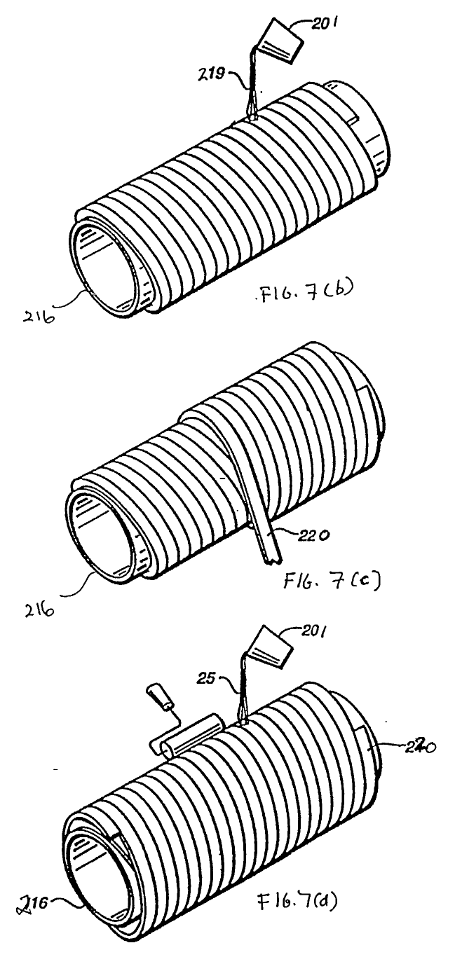

Embodiments of the invention can be described with reference to FIGS. 7(a)-7(d).

Referring to FIG. 7(a), a fluoropolymer film 281 may be spirally wrapped around a mandrel 216. In the final tubular structure formed, the fluoropolymer film 281 may form an inner liner of a tubular structure. Any of the above-described fluoropolymer films may be wrapped around the mandrel 216.

The mandrel 216 could be a tapered mandrel, or could be a mandrel with a constant diameter. If the mandrel 216 has a constant diameter, then it is possible to place cardboard and/or a plastic film over the mandrel 216 (as in, e.g., U.S. Pat. Nos. 5,308,423 and 5,306,371) to facilitate removal of the formed tubular structure. The mandrel 216 may be made of any suitable material including steel. The mandrel 216 may also have any suitable diameter. For instance, the diameter of the mandrel 216 may be, for example, from about 2 to about 84 inches in some embodiments. Although the mandrel 216 is in the form of a cylinder, it is understood that the mandrel could be curved (e.g., be in the form of an elbow) in some embodiments.

One or both surfaces of the fluoropolymer film 281 may have been treated, as described above, so that one or both sides of it are modified. For example, as described above, a reactive gas process, a corona process, or an etching process can be used to modify the surfaces of a fluoropolymer film 281. The fluoropolymer film 281 may be dispensed from a roll (not shown). Although the fluoropolymer film 281 may have any suitable width when dispensed from the roll, it may be six inches wide in some embodiments. It could be wider or narrower depending on the particular product being made.

Also, the fluoropolymer film 281 may have any suitable thickness. In some embodiments, a 3 mil thick fluoropolymer film 281 may be sufficient. In other embodiments, the thickness of the fluoropolymer film 281 may range from ½ mil to 10 mils (or more), depending on the application.

As shown in FIG. 7(a), the fluoropolymer film 281 may be wrapped around the mandrel 216 (while the mandrel 216 is turning) by a worker or automatically by appropriate machinery. When wrapping the fluoropolymer film 281 around the mandrel 216, the fluoropolymer film 281 can have an overlap by about one-half inch. Of course, the amount of overlap may vary. When the fluoropolymer film 281 is being wrapped around the mandrel 216, the mandrel 216 may be manually or automatically rotated to facilitate the winding of the fluoropolymer film around the mandrel 216.

When wrapping the fluoropolymer film 281 around the mandrel 216, an operator (or automatically by machinery) may apply a thin layer of a bonding material (e.g., a vinyl ester resin) at the point of the overlap, to make the fluoropolymer film 281 bond to itself (not shown in FIG. 7(a). A vinyl ester resin is preferably used as a bonding material because of its superior chemical resistance. Suitable vinyl ester resins are commercially available under the tradename Derakane, by Dow Chemical Inc. of Midland, Mich. Other bonding materials could also be used. Other exemplary bonding materials include vinyl-ester bonding materials, or fluoropolymer bonding materials (e.g., Viton™).

The helical seam formed by the overlapping points of the fluoropolymer film 281 can form the weakest point of the inner liner, in terms of corrosion resistance. Therefore, it is desirable to use a material that has chemical resistance and that can bond the fluoropolymer film 281 to itself. After the fluoropolymer film 281 bonds to itself, the process can then be temporarily stopped at this point to allow the bonding material to harden.

Other, commercially available resins that may be used to seal the overlapping regions of the fluoropolymer film 281 may include resins that are identified by the following generic names: (1) vinyl esters; (2) chlorendic anhydrides; (3) bisphenol fumarates; (4) isopthalic polyesters; (5) orthopthalic polyesters; and (6) epoxies with aromatic or aliphatic amines. Resins of the type (1)-(5) have resistance to acids and caustics, while the resins of the type (6) provide relatively good resistance to solvents and caustics. Fluoropolymer materials (e.g., Viton™) may also be used to seal overlapping regions.

As an alternative or in addition to using a bonding material to bond overlapping portions of the fluoropolymer film 281, the overlapping portions could be welded together. For example, heat or ultrasonic energy could be used to bond overlapping portions 281 of a fluoropolymer film together. The amount of heat or energy that is applied to the overlapping portions can be determined by the person of skill in the art. This can be done with or without a bonding material.

If a bonding material is used, once the bonding material hardens, an inner liner comprising the fluoropolymer film 281 is formed. The inner liner may serve as a substantially impermeable barrier layer to corrosive or caustic gases. The inner liner may have any suitable thickness. In some embodiments, the thickness of the inner liner may be less than about 100 mils (e.g., from about 20 to about 80 mils).

After the fluoropolymer film 281 is wrapped around the mandrel 216 and the inner liner is formed, a fiber-reinforced plastic layer is formed on the fluoropolymer film 281. The fiber-reinforced plastic layer may serve as the part of the tubular structure that provides it with structural integrity. One or more of such fiber-reinforced plastic layers may be present in the final tubular structure.

As shown in FIG. 7(b), the exterior of the wrapped layer 281 is wet out using a curable resin 219 provided from a resin source 201. Then, as shown in FIG. 1(c), a layer of fabric material 220 is wrapped on the fluoropolymer film 281 and is saturated with the curable resin 219. For example, a fabric material 220 comprising a three-quarter ounce chopped strand mat can be spirally wrapped around the mandrel 216. As shown in FIG. 7(d), the layer of fabric material 220 may be wet out with more resin, and then can be rolled out with a fiberglass roller to eliminate air pockets and excess resin in the layer of fabric material 220. At this point, the saturated layer of fabric material 220 may be cured, or it may be cured after additional fiber-reinforced plastic layers are formed on it. Curing may take place spontaneously in some embodiments (e.g., if a resorcinol-aldehyde resin system is used) or may take place using heat. Heat may be directed to the resin-saturated fabric material 220 using an external heat source to cure the resin. The curing temperature and time may depend on the particular resin being cured.

The resin material that saturates the fabric material 220 may include any suitable resin material. Exemplary resins include phenolic resins. One type of phenolic resin is a phenol-aldehyde resin. A suitable phenol-aldehyde resin is commercially available from Borden Chemical, Inc. Other exemplary resins include resorcinol-aldehyde, or phenol-resorcinol-aldehyde based resin systems. Examples of such resorcinol based systems are in U.S. Pat. Nos. 4,053,447, 4,076,873, 4,107,127, and 5,202,189. All of these patents are herein incorporated by reference in their entirety. Other types of resins include vinyl ester resins, polyester resins, epoxy resins, isopthalic resins, etc.

The fabric material 220 may be glass, random glass mat, woven roving, boat cloth, filament winding, or organic (or inorganic) veils as subsequent layers of glass in order to achieve the appropriate wall thicknesses required, based on the predetermined dimensions of the duct. For some applications, the aforesaid fabric materials may be impregnated with graphite or carbon fibers or even ceramic fibers to provide increased strength and fire resistance. Graphite and/or carbon fibers may also help to render the formed tubular structure conductive. As noted above, it is sometimes desirable to form a conductive tubular structure (e.g., a conductive duct) to dissipate static electricity.

Afterwards, an optional second layer of fabric material (not shown) may be wrapped around the first layer of fabric material 220 (not shown in FIGS. 7(a)-7(d)). The second layer of fabric material may be a three-quarter ounce mat that is helically wrapped around the first layer of fabric material 220, and is then wet out with the same (or different) resin material that is used to saturate the first layer of fabric material 220. The saturated second layer of fabric material may then be rolled out in the same manner as the first layer of fabric material 220. The mat that is used in the first layer of fabric material 220 and the second layer of fabric material may be, for example, three-quarter ounce mat. However, one and one-half ounce mat could also be used in other embodiments.

Then, an optional filament winding glass that is wet out with the same or different resin material is applied to the combination of materials on the mandrel 216 (not shown in FIGS. 7(a)-7(d)). The filament winding glass may be wound in a helical wind pattern around the mandrel 216. The filament winding glass may be of any suitable yield. For example, a filament winding glass that is 250 yield can be used. In other embodiments, a 450 or 675 yield winding glass could be used. The filament winding glass may be wet out with resin before being applied to the previously wound layers of fabric material.

A finishing layer made with another fabric material such as boat cloth can be formed on the previously described layer to achieve a relatively smooth exterior in the final tubular structure. The layer of fabric material may be saturated with resin, and then rolled, as previously described.

In some embodiments, a fluoropolymer layer could be formed as an outer layer of a tubular structure. This can be desirable if the outer surface of the tubular structure 110 is intended to be resistant to corrosive, caustic, or oxidizing fluids. The outer fluoropolymer layer can be formed in the same manner as the inner fluoropolymer layer formed using the fluoropolymer film 281.

Then, the finished tubular structure may be baked at approximately 150-180° F. for 20-30 minutes. Of course, the baking temperature and time may depend on the particular resins used to form the tubular structure, the size of the tubular structure formed, the number of layers present, etc. After the tubular structure is baked, and the resin in the tubular structure is cured, it is pulled from the mandrel 216. In other embodiments, a resin in the tubular structure can cure at ambient temperatures. Processes that are known in the art can be used to pull the tubular structure from the mandrel. For example, the mandrel 216 can be restrained while the tubular structure on it is pulled.

Other modifications are possible. For example, instead of having a first and a second layer of fabric material wound around the mandrel 216, only one layer of fabric material may be wrapped around the mandrel 216 in other embodiments.

Embodiments of the invention are designed to pass the Duct Test Standard Number #4922 Test, developed by Factory Mutual Research. Factory Mutual Research (FM), is associated with a number of large industrial insurers, and developed a Duct Test Standard Number #4922, which they and their associated mutual insurers felt were predictive of real world results when plastic ducts are involved in fire. Other insurers have adopted the FM #4922 Test as their own criteria to determine whether or not plastic ductwork should have sprinklers on their interior.

In the FM test, a flame from a pan of heptane is generated within an enclosure and is pulled into one end of a 12″ round by 24 foot long duct by a fan operating at 600 ft./min. At the opposite end, an exhaust fan sucks the flame into the duct, which simulates an exhaust duct system. A series of thermocouples are spaced apart along the duct and are connected to a recorder. The test is a go/no-go criteria. To pass the test, the duct may not burn from one end to the other in a period of 15 minutes; and a thermocouple sensor near the fan end may not register 1000 degrees F. A sight hole is located about 23 feet from the fire end should not exhibit any flame. If the non-metallic duct cannot pass this criteria, then the non-metallic ductwork must have sprinklers installed on their interior by Factory Mutual standards.

Another aspect of the FM #4922 test is the smoke removal criteria. In this procedure, the air velocity is equal to about 2000 ft/min (609.6 m/min). The test is performed for 10 minutes. The smoke removal is approved if (1) the duct retains its integrity, and (2) no smoke was emitted from the surface of the fire exposed end or from the exterior surface of the duct (during the fire test).

With the broadening use of so-called clean rooms as used in the semiconductor industry, Factory Mutual modified their tests to take the above criteria into consideration; i.e., the exterior of the duct should not be permitted to smoke excessively, nor should the duct be permitted to collapse. The reason for these requirements was that air within clean rooms is re-circulated at a very high rate. Thus, for ductwork installed in the vicinity of the clean rooms, smoke from the exterior of the duct during a fire would be circulated into the clean room area and if the duct collapsed, exhaust from the area would be impossible. Such conditions would contaminate products contained within the clean room, its equipment, and the clean room surfaces themselves resulting in extensive damage costs. Therefore, the fire and smoke properties of plastic exhaust ducts became increasingly important as the cleanliness requirements for clean room environment increased. Embodiments of the invention are designed to pass the FM #4922 test.

Besides being able to pass the above-described FM test, embodiments of the invention have a number of other advantages. First, embodiments of the invention can be made quickly. Some embodiments of the invention can be made in approximately 2 hours (versus 6 hours for other conventional or other ambient cured, phenolic ducts) when a quick curing resin is used for the outer layer. The inner liner formed from the wrapped fluoropolymer film can be formed quickly and efficiently in comparison to an inner liner that is formed using a resin-impregnation process. Second, because a pre-formed layer is used to form the tubular structure, the odors in the manufacturing facility used to create the tubular structure are reduced. For example, large amounts of volatile chemicals such as vinyl ester resins (with styrene) would not be needed in embodiments of the invention. Third, fluoropolymers give off less smoke, when burned, than other materials such as vinyl esters. Fourth, the fluoropolymer liner is lighter in weight and can be made thinner than inner liners in conventional ducts.

All U.S. Patents, U.S. Patent Applications, and publications mentioned above are herein incorporated by reference for all purposes.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention. For example, features (e.g., the types of fluoropolymer materials mentioned) disclosed with respect to the metal/fluoropolymer film tubular structure embodiments can be combined with features disclosed with respect to the fiberglass reinforced plastic tubular structure embodiments without departing from the spirit and scope of the invention.

What is claimed is:

1. A method for making a tubular structure, the method comprising:
(a) modifying a surface of a fluoropolymer film;
(b) after (a), bonding the fluoropolymer film to a metal layer, thereby forming a composite sheet; and
(c) shaping the composite sheet into a tubular structure.

2. The method of claim 1 wherein the tubular structure is a duct.

3. The method of claim 1 wherein modifying the surface comprises exposing the surface to a gaseous mixture comprising oxygen and fluorine.

4. The method of claim 1 further comprising, after (a) and before (b), applying an adhesive to the modified surface.

5. The method of claim 1 wherein shaping comprises spirally winding the composite sheet.

6. The method of claim 1 wherein modifying the surface comprises modifying the contact angle of the surface of the fluoropolymer film.

7. The method of claim 1 wherein modifying the surface of the fluoropolymer film comprises exposing the surface to a corona discharge, a plasma etch, or a sodium etch process.

8. The method of claim 1 wherein the fluoropolymer film comprises PTFE, FEP, ECTFE, or ETFE.

9. The method of claim 1 wherein shaping comprises spirally winding the composite sheet and forming a helical seam.

10. A tubular structure comprising:
(a) a metal layer;
(b) a fluoropolymer film;
(c) an adhesive layer between the metal layer and the fluoropolymer film; and
(d) a helical seam formed in the tubular structure.

11. The tubular structure of claim 10 wherein the adhesive layer is in direct contact with the fluoropolymer film and the metal layer.

12. The tubular structure of claim 10 wherein the tubular structure is a duct.

13. The tubular structure of claim 10 wherein the fluoropolymer film comprises an ethylene-chlorotrifluoroethylene copolymer.

14. The tubular structure of claim 10 wherein the metal layer comprises aluminum.

15. A method for forming a tubular structure, the method comprising:
(a) wrapping a surface modified fluoropolymer film around a mandrel;
(b) wrapping a layer of fabric material on the fluoropolymer film and saturating the layer of fabric material with a resin material;
(c) curing the resin material to form a tubular structure; and
(d) removing the tubular structure from the mandrel.

16. The method of claim 15 wherein further comprising, after (b), but before (c):
rolling the resin-saturated layer of fabric material.

17. The method of claim 15 wherein the resin material includes a phenolic resin.

18. The method of claim 15 wherein the surface modified fluoropolymer film is modified using a sodium etch process, a corona discharge process, or a reactive gas process.

19. An air duct comprising:
(a) an inner fluoropolymer film with a modified surface; and
(b) an outer, cured resin-impregnated fabric layer.

20. The air duct of claim 19 further comprising an intermediate layer comprising a cured resin layer between the fluoropolymer film and the outer, cured resin-impregnated fabric layer.

21. The air duct of claim 19 wherein the fluoropolymer film comprises ECTFE, FEP, PTFE, or ETFE.

22. The air duct of claim 19 wherein the fluoropolymer film and the outer, cured resin-impregnated layer are in direct contact.

23. The air duct of claim 19 wherein the air duct further comprises one or more additional layers on the outer layer.

24. The air duct of claim 19 wherein the modified surface of the fluoropolymer film was modified using a sodium etch process, a corona discharge process, or a reactive gas process.

25. The air duct of claim 19 further comprising an intermediate adhesive layer between the fluoropolymer film and the outer, cured resin-impregnated fabric layer.
